(19) United States
(12) Patent Application Publication
(10) Pub. No.: US 2011/0054889 A1
(43) Pub. Date: Mar. 3, 2011

(54) Enhancing Receiver Intelligibility in Voice Communication Devices

(75) Inventors: Alon Konchitsky, Santa Clara, CA (US); Alberto D. Berstein, Cupertino, CA (US); Sandeep Kulakcherla, Santa Clara, CA (US); William Martin Ribble, San Jose, CA (US)

(73) Assignee: Mr. Alon Konchitsky, Santa Clara, CA (US)

(21) Appl. No.: 12/941,827

(22) Filed: Nov. 8, 2010

Related U.S. Application Data
(63) Continuation of application No. 12/139,489, filed on Jun. 15, 2008.
(60) Provisional application No. 60/944,180, filed on Jun. 15, 2007.

(51) Int. Cl. G10L 21/02

(52) U.S. Cl. 704/226

(57) ABSTRACT

The intelligibility of speech signals is improved in the many situations where a voice signal is communicated or stored. Means and methods are disclosed for developing a scheme with high voice signal intelligibility without sacrifice of voice quality. The disclosed method comprises certain steps, including, but not limited to: Learning the noise on near-end side and enhancing the far-end voice as a function of the noise level on the near-end side. The disclosed method and apparatus are especially useful to increase the intelligibility of the cell phone's loudspeaker output. The invention includes the processing of an input speech signal to generate an enhanced intelligent signal. In frequency domain, the FFT spectrum of the speech received from the far-end is modified in accordance with the LPC spectrum of the local background noise to generate an enhanced intelligent signal. In time domain, the speech is modified in accordance with the LPC coefficients of the noise to generate an enhanced intelligent signal.

### CROSS-REFERENCE TO RELATED APPLICATIONS

This application claims the benefit of U.S. provisional patent application 60/944,180 filed on Jun. 15, 2007, entitled “Receiver Intelligibility Enhancement System” and incorporates by reference the entire contents of the prior application.

This application is a continuation in part application of application Ser. No. 12/139,489 filed on Jun. 15, 2008 and claims the benefit and priority date of copending application Ser. No. 12/139,489. Said priority date being the filing date of Jun. 15, 2007 for provisional patent application 60/944,180.

### BACKGROUND OF THE INVENTION

1. Field of the Invention

The invention relates generally to any communication technology. More particularly, the invention relates to means and methods of improving voice signal quality by consideration and use of background noise.

Speech intelligibility is usually expressed as a percentage of words, sentences or phonemes correctly identified by a listener or a group of listeners. It is an important measure of the effectiveness or adequacy of a communication system or of the ability of people to communicate effectively in noisy environments. Quality is a subjective measure which reflects on individual preferences of listeners. The two measures are not correlated. In fact, it is well known that intelligibility can be improved if one is willing to sacrifice quality. It is also well known that improving the quality of the noisy signal does not necessarily elevate its intelligibility. On the contrary, quality improvement is usually associated with loss of intelligibility relative to that of the noisy signal. This is due to distortion the clean signal undergoes in the process of suppressing the background noise.

2. Description of the Related Art

Different kinds of communication devices are used in different environments. They are used at home, crowded bars, stadium, shopping malls vehicles and in other areas which have different levels of background noise. A high level of local background noise may impede or hinder a user's ability to understand the speech being received in the communication device. The ability of the user to effectively understand the speech received from the far-end is obviously essential and is referred to as the intelligibility of the received speech.

In the past, the most common solution to overcome background noise was to increase the volume at which the phone's earpiece or the speaker that outputs speech. One problem with this solution is that the maximum output sound level that a communication device's speaker can generate is limited. Due to the need to produce cost-competitive communication devices, the related art may often use low-cost speakers with limited power handling capabilities. The maximum sound level that such communication device's speakers generate is often insufficient due to high local background noise.

Attempts to overcome the local background noise by simply increasing the volume of the speaker output may also result in overloading the speaker. Overloading the loudspeaker introduces distortion to the speaker output and further decreases the intelligibility of the outputted speech. A technology that increases the intelligibility of speech received irrespective of the local background noise level is needed.

Several attempts to improve the intelligibility in communication devices are known in the related art. The requirement of an intelligent system considers the naturalness of the enhanced signal, a short signal delay and computational simplicity.

During the past two decades, linear predictive coding or “LPC” has become one of the most prevalent techniques for speech analysis. In fact, this technique is the basis of all the sophisticated algorithms that are used for estimating speech parameters, such as, pitch, formants, spectra, vocal tract and low bit representations of speech. The basic principle of linear prediction states that speech can be modeled as the output of a linear time-varying system excited by either periodic pulses or random noise. The most general predictor form in linear prediction is the Auto Regressive Moving Average (ARMA) model where a speech sample of s(n) is predicted from p past predicted speech samples s(n−1), . . . , s(n−p) with the addition of an excitation signal u(n) according to the following

$$s ( n ) = {\sum }_{k = 1}^{p} {a}_{k} s ( n - i ) + G {\sum }_{l = 0}^{q} {b}_{l} u ( n - l )$$

Where G is the gain factor for the input speech and aₖ and bₗ are filter coefficients. The related transfer function H(z) is

$$H ( z ) = \frac{S ( z )}{U ( z )}$$

For an all-pole or autoregressive (AR) model, the transfer function becomes

$$H ( z ) = \frac{1}{1 - {\sum }_{k = 1}^{p} {a}_{k} {z}^{- k}} = \frac{1}{A ( z )}$$

Estimation of LPC

Two widely used methods for estimating the LP coefficients are existed: Autocorrelation method and Covariance method.

Both methods choose the LP coefficients {aₖ} in such a way that the residual energy is minimized. The classical least squares technique is used for this purpose. Among different variations of LP, the autocorrelation method of linear prediction is the most popular. In this method, a predictor (an FIR of order m) is determined by minimizing the square of the prediction error, the residual, over an infinite time interval. Popularity of the conventional autocorrelation method of LP is explained by its ability to compute a stable all-pole model for the speech spectrum, with a reasonable computational load, which is accurate enough for most applications when presented by a few parameters. The performance of LP in modeling of the speech spectrum can be explained by the autocorrelation function of the all-pole filter, which matches exactly the autocorrelation of the input signal between 0 and m when the prediction order equals m. The energy in the residual signal is minimized. The residual energy is defined as:

$$E = {\sum }_{n = - ∞}^{∞} {e}^{2} ( n ) = {\sum }_{n = - ∞}^{∞} {( {s}_{N} ( n ) - \sum {a}_{k} {s}_{N} ( n - k ) )}^{2}$$

The covariance method is very similar to the autocorrelation method. The basic difference is the length of the analysis window. The covariance method windows the error signals instead of the original signal. The energy E of the windowed error signal is

$$E = {\sum }_{n = - ∞}^{∞} {e}^{2} ( n ) = {\sum }_{n = - ∞}^{∞} {e}^{2} ( n ) w ( n )$$

Comparing autocorrelation method and covariance method, the covariance method is quite general and can be used with no restrictions. The a problem is that of stability of the resulting filter, which is not a severe problem generally. In the autocorrelation method, on the other hand, the filter is guaranteed to be stable, but the problems of parameter accuracy can arise because of the necessity of windowing the time signal. This is usually a problem if the signal is a portion of an impulse response.

The Line Spectrum Pair (LSP) decomposition was first introduced by Itakura in 1975. It is mainly used as a convenient representation of LP coding. There are also some other representations of LP parameters, such as Reflection Coefficients (RC), Autocorrelations (AC), Log Area Ratios (LAR), Arcsine of Reflection Coefficients (ASRC), Impulse Response of LP synthesis filter (IR).

The LSP decomposition has many advantages than others. In this technique, the minimum phase predictor polynomial computed by the autocorrelation method of linear prediction is split into a symmetric and an anti-symmetric polynomial. It has been proved that the roots of these two polynomials, the LSPs, are located interlaced on the unit circle, if the original LP predictor is minimum phase. Furthermore, the LSPs behave well when interpolated. Due to these properties, the LSP decomposition has become the major technique in quantization of LP information and it is used in various speech coding algorithms.

The LSP based on the principle of Linear Predictive Coding (LPC) plays a very important role in the speech synthesis; it has many interesting properties. Several famous speech compression/decompression algorithms, including the famous Code Excited Linear Predictive coding (CELP), are based on the LSP analysis, where the information loss or predicting errors are often very small due to the LSPs characteristics. It was found that this new representation has such interesting properties as (1) all zeros of LSP polynomials are on the unit circle, (2) the corresponding zeros of the symmetric and anti-symmetric LSP polynomials are interlaced, and (3) the reconstructed LPC all-pole filter preserves its minimum phase property if (1) and (2) are kept intact through a quantization procedure.

Given a specific order for the vocal track model of the speech to be analyzed, LPC analysis results in an all-zero inverse filter

$$A ( z ) = {A}_{p} ( z ) = 1 + {\sum }_{p = 1}^{P} {a}_{p} {z}^{- p}$$

which minimizes the residual energy. In speech compression and quantization based speech recognition, the LPC coefficients {a₁, a₂, . . . , aₚ} are known to be inappropriate for quantization because of their relatively large dynamic range and possible filter instability problems. Different set of parameters representing the same spectral information, such as Reflection Coefficients and Log Area Ratios, etc., were thus proposed for quantization in order to alleviate the above mentioned problems. LSP is one such kind of representation of spectral information. LSP parameters have both well-behaved dynamic range and filter stability preservation property, and can be used to encode LPC spectral information even more efficiently than any other parameters.

In recent audio-coding algorithms four key technologies play an important role: perceptual coding, frequency-domain coding, window switching, and dynamic bit allocation. We only deal with masking in the current invention.

Auditory Masking

The inner ear performs short-term critical band analyses where frequency-to-place transformations occur along the basilar membrane. The power spectra are not represented on a linear frequency scale but on limited frequency bands called critical bands. The auditory system can roughly be described as a band-pass filter-bank, consisting of strongly overlapping band-pass filters with bandwidths in the order of 50 to 100 Hz for signals below 500 Hz and up to 5000 Hz for signals at high frequencies.

Simultaneous Masking

A frequency domain phenomenon where a low-level signal (the maskee) can be made inaudible (masked) by a simultaneously occurring stronger signal (the masker) as long as masker and maskee are close enough in frequency. Such masking is largest in the critical band in which the masker is located, and it is effective to a lesser degree in neighboring bands. A masking threshold can be measured and low-level signals below this threshold will not be audible.

Temporal masking

In addition to simultaneous masking, the time-domain phenomenon of temporal masking plays an important role in human auditory perception. It may occur when two sounds appear within a small interval of time. Depending on the individual Sound Pressure Level (SPL), the stronger sound may mask the weaker one, even if the maskee precedes the masker. The duration within which pre-masking applies is significantly less than one tenth of that of the post-masking, which is in the order of 50 to 200 ms.

### SUMMARY OF THE INVENTION

The present invention provides a novel system and method for monitoring the noise in the environment in which a communication device is operating and enhances the received signal in order to make the communication more relaxed. By monitoring the ambient or environmental noise in the location in which the communication device is operating and applying receiver intelligibility enhancement processing at the appropriate time, it is possible to significantly improve the intelligibility of the received signal.

In one aspect of the invention, the invention provides a system and method that enhances the convenience of using a communication device, even in a location having relatively loud ambient or environmental noise. In another aspect of the invention, the invention optionally provides an enable/disable switch on a communication device to enable/disable the receiver intelligibility enhancement. These and other aspects of the present invention will become apparent upon reading the following detailed description in conjunction with the associated drawings. The present invention can be employed in communication devices to improve the speech outputted by a loudspeaker or earpiece located in the phone handset.

The FFT spectrum of the incoming speech is modified in accordance with the LPC spectrum of the local background noise. The regions that are masked by the noise are boosted adaptively to produce an intelligent enhanced signal. By these and other means and methods disclosed herein, the present invention overcomes shortfalls in the related art and achieves unexpected results. The invention obtains economies in hardware, power consumption and other useful, tangible, and unexpected results. Other objects and advantages will be made apparent when considering the following detailed specifications when taken in conjunction with the drawings.

### BRIEF DESCRIPTION OF THE DRAWINGS

FIG. 1 is diagram of an exemplary embodiment of a receiver intelligibility system constructed in accordance with the principles of the invention

FIG. 2a is diagram of an exemplary embodiment of the invention showing the FFT and LPC spectra of babble noise superimposed.

FIG. 2b is diagram of an exemplary embodiment of the invention showing the FFT and LPC spectra of car noise superimposed.

FIG. 2c is diagram of an exemplary embodiment of the invention showing the FFT and LPC spectra of wind noise superimposed.

FIG. 3a is diagram of an exemplary embodiment of the invention showing the time domain plot of babble noise on one channel and pure speech of a male on the other channel.

FIG. 3b is diagram of an exemplary embodiment of the invention showing the time domain plot of car noise on one channel and pure speech of a female on the other channel.

FIG. 3c is diagram of an exemplary embodiment of the invention showing the time domain plot of wind noise on one channel and pure speech of a female on the other channel.

FIG. 4 is a diagram of an exemplary embodiment of the invention showing the flowchart of processing for improving the receiver intelligibility.

### DETAILED DESCRIPTION OF THE PREFERRED EMBODIMENTS

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout. Unless otherwise noted in this specification or in the claims, all of the terms used in the specification and the claims will have the meanings normally ascribed to these terms by workers in the art.

The present invention provides a novel and unique technique to improve the intelligibility in noisy environments experienced in communication devices such as a cellular telephone, wireless telephone, cordless telephone, VoIP phones, Bluetooth headsets etc. While the present invention has applicability to at least these types of communications devices, the principles of the present invention are particularly applicable to all types of communications devices, as well as other devices that process speech in noisy environments such as voice recorders, dictation systems, voice command and control systems, and other systems. For simplicity, the following description employs the term “telephone” or “cellular telephone” or “mobile phone” or “wireless phone” or “cordless phone” or “VoIP phones” or “Bluetooth headset” as an umbrella term to describe the embodiments of the present invention, but those skilled in the art will appreciate that the use of such a term is not to be considered limiting to the scope of the invention, which is set forth by the claims appearing at the end of this description.

Hereinafter, preferred embodiments of the invention will be described in detail in reference to the accompanying drawings. It should be understood that like reference numbers are used to indicate like elements even in different drawings. Detailed descriptions of known functions and configurations that may unnecessarily obscure the aspect of the invention have been omitted.

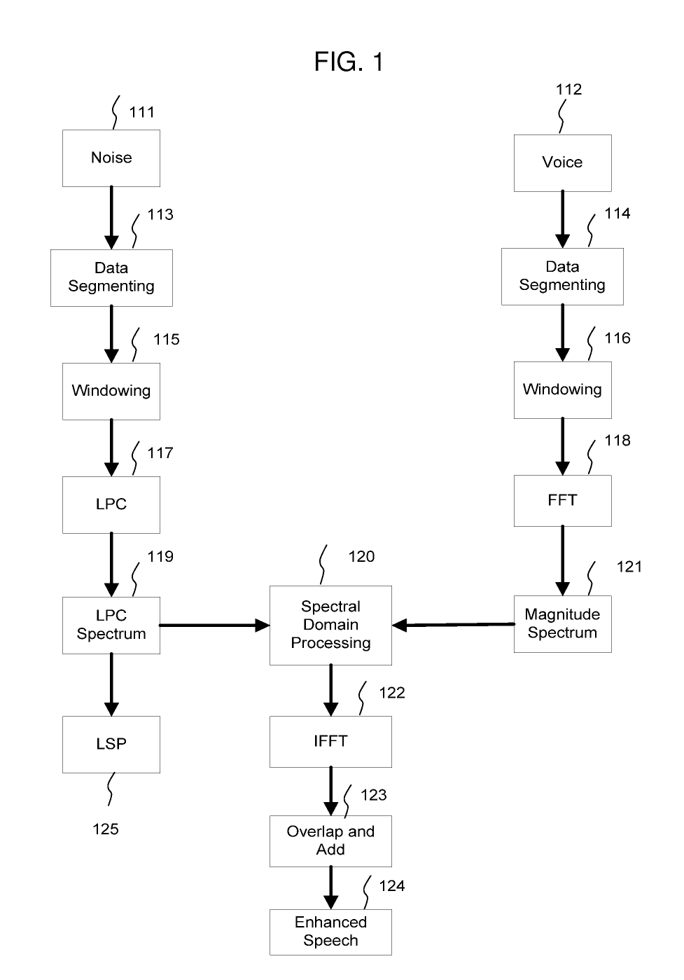

In FIG. 1, the noise buffer, 111 and speech buffer, 112 are processed separately. The noise and speech signals are first data segmented, 113 and 114 respectively and then windowed, 115 and 116 using a Hanning window. The LPC coefficients, at 117 and FFT of speech, at 118 are calculated. The magnitude spectrum of speech, calculated at 121, is modified at 120 in accordance with the LPC spectrum, calculated at 119 in regions where the speech is masked by noise. The time domain signal is reconstructed by taking the IFFT, at 122 and overlap and add method, 123 to produce an enhanced speech signal 124.

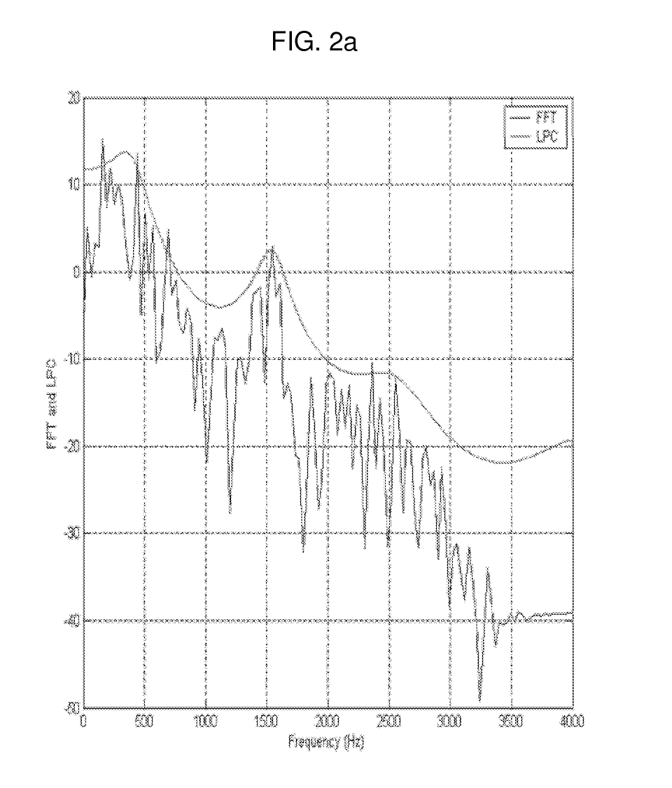

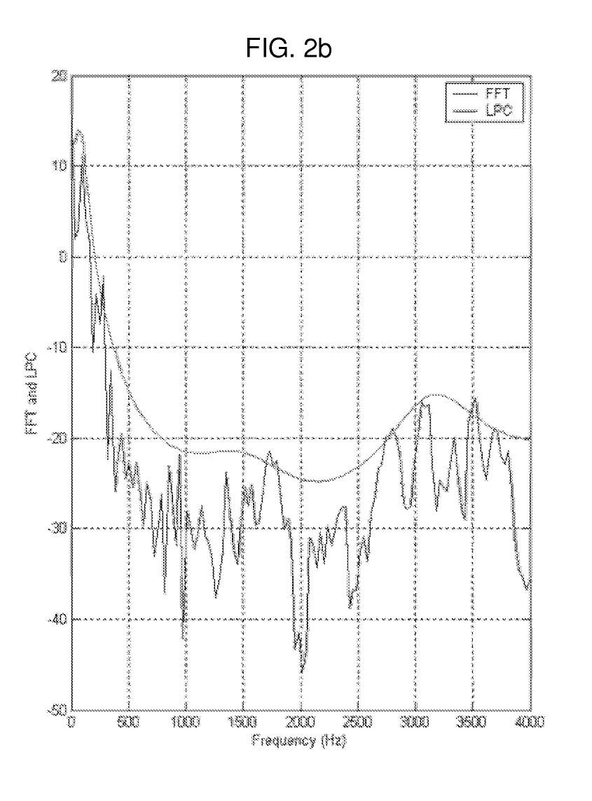

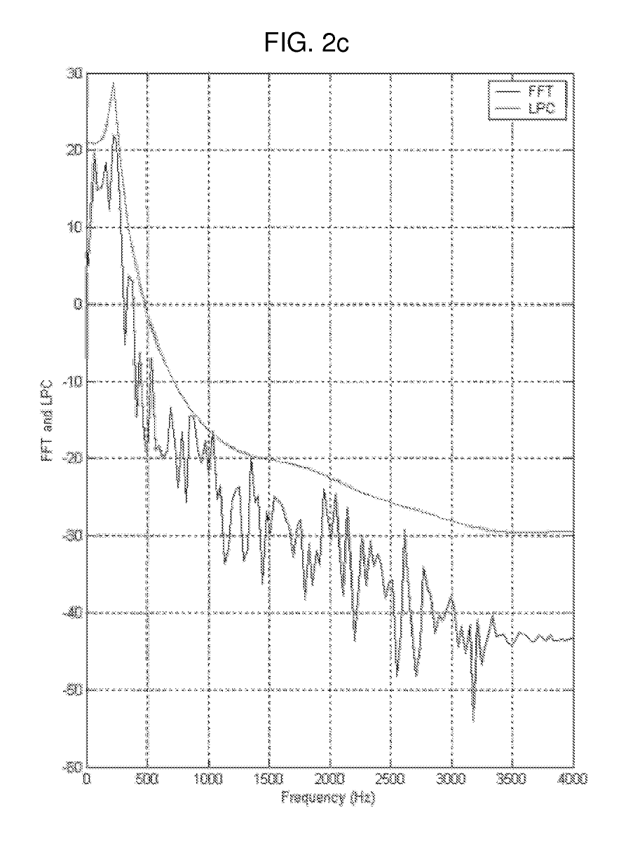

FIG. 2a shows the plot of FFT and LPC spectra of babble noise. FIG. 2b shows the plot of FFT and LPC spectra of car noise. FIG. 2c shows the plot of FFT and LPC spectra of wind noise.

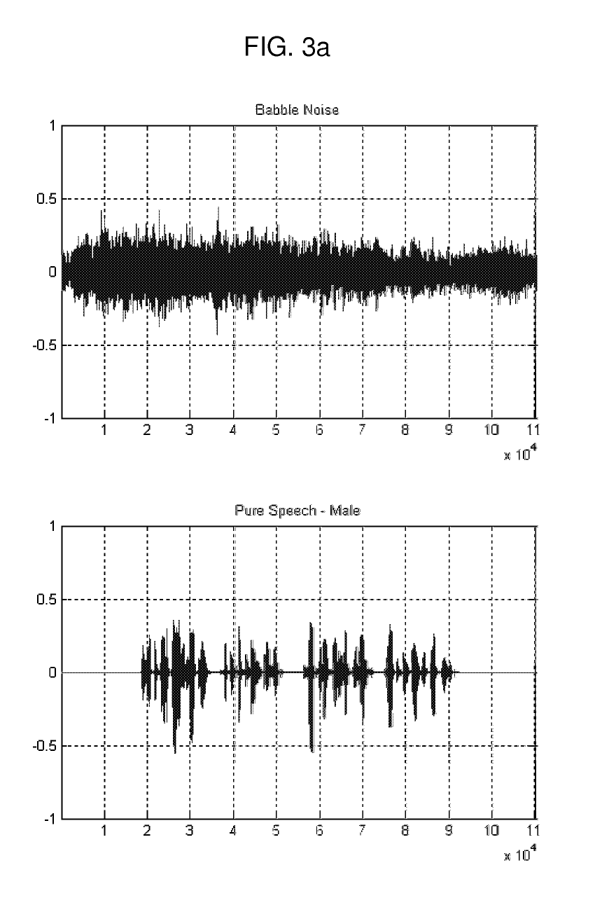

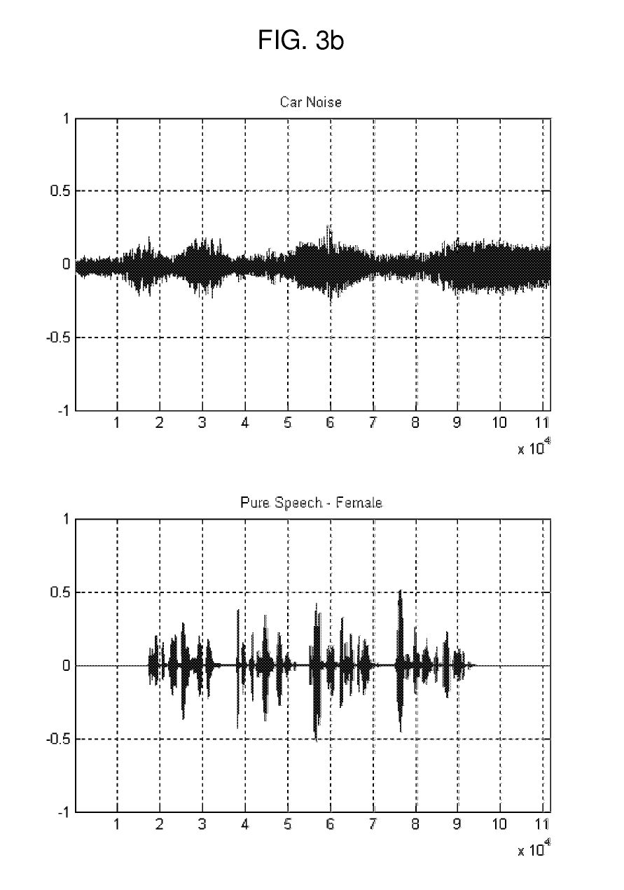

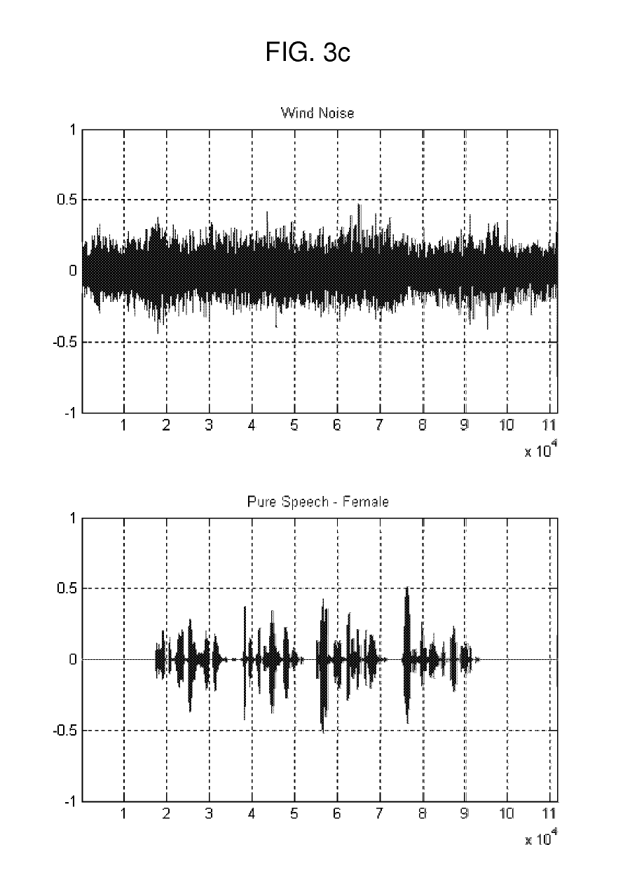

FIG. 3a shows the plot of time domain signal of babble noise on one channel and pure speech of male on the other channel. The noise shown is typically the local background noise present on the near-end side, and the speech shown is the speech coming from the far-end side where there is no noise. FIG. 3b shows the time domain signal of car noise on the left channel and pure speech of female on the other channel. Similarly, FIG. 3c shows the time domain signal of wind noise on the left channel and pure speech of female on the other channel.

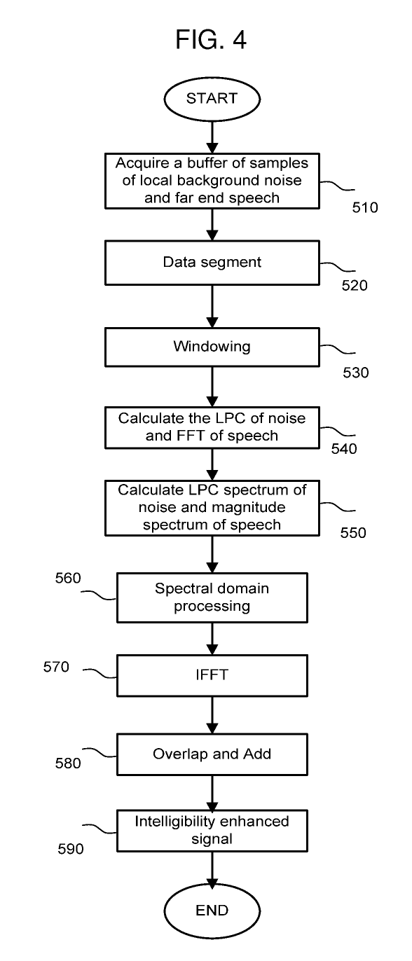

FIG. 4 shows the detailed flowchart of the processing for improving the receiver intelligibility. Block 510 acquires a buffer of samples of local background noise on the near-end and far-end pure speech. This acquisition of speech and noise is done separately. At block 520, the buffers are segmented and then windowed at block 530. At block 540, the LPC coefficients of near-end noise and FFT of far-end speech are calculated. Block 550 calculates the LPC spectrum of near-end noise and magnitude spectrum of far-end speech.

At block 560, the processing is carried out. In this processing, the magnitude spectrum of far-end speech is modified in accordance with the LPC spectrum of the near-end speech. The frequency regions which are masked the noise components are boosted adaptively, so that the effect of masking is minimized. The time domain signal is reconstructed using the IFFT block of 570 and overlap and add method at 580. The intelligibility enhanced signal is outputted at block 590.

The invention includes, but is not limited to the following items:

Item 1. A method for improving receiver intelligibility comprising:

a) acquiring, by a communication device, a first noise signal buffer of local background noise and acquiring, by the communication device, a second speech signal buffer of far end speech signals, wherein the far end speech signal is received from a far-end side;

b) segmenting, by the communication device, the contents of the first noise signal buffer and the second noise signal buffer;

c) windowing, by the communication device, the segmented contents of the first noise signal buffer and the second speech signal buffer;

d) estimating, by the communication device, noise power of the first noise signal buffer;

e) removing, by the communication device, d.c. components from both the first noise signal buffer and the second speech signal buffer

f) calculating, by the communication device, LPC coefficients of noise signal of the first noise signal buffer;

g) varying, by the communication device, two gains of speech from the first noise signal buffer and the second speech signal buffer to maintain a SNR and accepting the estimated noise power from step d above;

h) filtering, by the communication device, the second buffered speech signal buffer using LPC coefficients to obtain a filtered speech signal; and

i) adding, by the communication device, the filtered speech signal to an unmodified speech signal from the second buffered speech signal modified by a first gain to the unfiltered speech signal buffer modified by a second gain to create a new speech signal with improved intelligibility, wherein the new speech signal is reproduced by an earphone of the communication device.

Item 2. A method for improving receiver intelligibility comprising:

a) obtaining, by a communication device, a first noise signal buffer of local background noise and acquiring, at a communication device, a second speech signal buffer of far end speech, wherein the first noise signal buffer and the second speech signal buffer which are each separately segmented and windowed using a hanning window by the communication device;

b) calculating or estimating, by the communication device, noise power and then removing d.c. components from the noise;

c) attenuating, by the communication device, the speech buffer using a gain and then filtered using LPC coefficients that are calculated by input of the d.c. removal of noise and speech gain;

d) controlling, by the communication device, adaptively a second gain which attenuates the speech directly; and

e) adding, by the communication device, output from the second gain and the speech signal filtered by the LPC coefficients to produce a transformed speech signal with improved intelligibility, and wherein the transformed speech signal is reproduced by an earphone of the communication device.

While the invention has been described with reference to a detailed example of the preferred embodiment thereof, it is understood that variations and modifications thereof may be made without departing from the true spirit and scope of the invention. Therefore, it should be understood that the true spirit and the scope of the invention are not limited by the above embodiment, but defined by the appended claims and equivalents thereof.

What is claimed is:

1. A method for improving receiver intelligibility comprising:
a) acquiring, by a communication device, a first noise signal buffer of local background noise and acquiring, by the communication device, a second speech signal buffer of far end speech signals, wherein the far end speech signal is received from a far-end side;
b) segmenting, by the communication device, the contents of the first noise signal buffer and the second noise signal buffer;
c) windowing, by the communication device, the segmented contents of the first noise signal buffer and the second speech signal buffer;
d) estimating, by the communication device, noise power of the first noise signal buffer;
e) removing, by the communication device, d.c. components from both the first noise signal buffer and the second speech signal buffer
f) calculating, by the communication device, LPC coefficients of noise signal of the first noise signal buffer;
g) varying, by the communication device, two gains of speech from the first noise signal buffer and the second speech signal buffer to maintain a SNR and accepting the estimated noise power from step d above;
h) filtering, by the communication device, the second buffered speech signal buffer using LPC coefficients to obtain a filtered speech signal; and
i) adding, by the communication device, the filtered speech signal to an unmodified speech signal from the second buffered speech signal modified by a first gain to the unfiltered speech signal buffer modified by a second gain to create a new speech signal with improved intelligibility, wherein the new speech signal is reproduced by an earphone of the communication device.

2. A method for improving receiver intelligibility comprising:
a) obtaining, by a communication device, a first noise signal buffer of local background noise and acquiring, at a communication device, a second speech signal buffer of far end speech, wherein the first noise signal_buffer and the second speech signal buffer which are each separately segmented and windowed using a hanning window by the communication device;
b) calculating or estimating, by the communication device, noise power and then removing d.c. components from the noise;
c) attenuating, by the communication device, the speech buffer using a gain and then filtered using LPC coefficients that are calculated by input of the d.c. removal of noise and speech gain;
d) controlling, by the communication device, adaptively a second gain which attenuates the speech directly; and
e) adding, by the communication device, output from the second gain and the speech signal filtered by the LPC coefficients to produce a transformed speech signal with improved intelligibility, and wherein the transformed speech signal is reproduced by an earphone of the communication device.
